(19) United States
(12) Patent Application Publication
(10) Pub. No.: US 2026/0160612 A1
(43) Pub. Date: Jun. 11, 2026

(54) ACTIVATABLE THERMAL INDICATOR WITH THICKNESS COMPENSATION LAYER

(71) Applicant: Temptime Corporation, Morris Plains, NJ (US)

(72) Inventors: Brian S. HUFFMAN, Belle Mead, NJ (US); Eric W. LIBERATO, Pequannock, NJ (US); Mohannad ABDO, Clifton, NJ (US)

(73) Assignee: Temptime Corporation, Morris Plains, NJ (US)

(21) Appl. No.: 18/970,147

(22) Filed: Dec. 5, 2024

(51) Int. Cl. G01K 11/06

(52) U.S. Cl. CPC G01K 11/06

(57) ABSTRACT

Activatable indicators with thickness compensation layers are disclosed herein. An example activatable indicator with a thickness compensation layer may be provided by a activatable environmental exposure indicator including a substrate, an indicator region operatively coupled to the substrate, a planarization layer, at least partially overlaying the substrate, a reservoir disposed on or in the substrate, at least partially surrounded by the planarization layer, in fluid communication with the indicator region, a plurality of microcapsules contained in the reservoir, each microcapsule of the plurality of microcapsules containing a payload microencapsulated in a frangible shell, a depressible cover aligned with and covering the reservoir.

### BACKGROUND

Environmental indicators may be configured to indicate the occurrence of an environmental exposure to a host product. Prior to the association between the host product and the indicator, the same level of care must often be paid to the indicator to prevent an exposure to the environmental condition which the indicator is configured to indicate, so that the indicator is not triggered prematurely and rendered unusable for use with the host product. For example, high temperature exposure indicators may need to be kept in deep freeze or refrigerated conditions, complicating the component supply chains for the products they are used with. Activatable environmental indicators have been previously proposed.

### SUMMARY

In a first embodiment, the technology of the present disclosure may be provided by an activatable environmental exposure indicator including a substrate, an indicator region operatively coupled to the substrate, a planarization layer, at least partially overlaying the substrate, a reservoir disposed on or in the substrate, at least partially surrounded by the planarization layer, in fluid communication with the indicator region, a plurality of microcapsules contained in the reservoir, each microcapsule of the plurality of microcapsules containing a payload microencapsulated in a frangible shell, and a depressible cover aligned with and covering the reservoir. The payload comprises a liquefiable material configured to liquefy responsive to a predetermined environmental exposure. The frangible shells are configured to rupture responsive to an activation action exceeding an activation threshold, releasing the payload from the frangible shells. After being released from the frangible shells, and responsive to the predetermined environmental exposure causing liquefication of the liquefiable material, the payload is configured to migrate into the indicator region producing an observable effect in the indicator region. The frangible shells are configured to block the payload from migrating to the indicator region prior to the activation action. The depressible cover is configured to permit the activation action to be applied to the plurality of microcapsules by applying a compressive force to the depressible cover.

In a second embodiment, the technology of the present disclosure may be provided by an activatable environmental exposure indicator including a substrate; a planarization layer, at least partially overlaying the substrate; an indicator region operatively coupled to the substrate and at least partially surrounded by the planarization layer; a first plurality of microcapsules disposed in the indicator region, each microcapsule of the first plurality of microcapsules containing a payload microencapsulated in a frangible shell, and a depressible cover aligned with and covering the indicator region. The payload comprises a liquefiable material configured to liquefy responsive to a predetermined environmental exposure, and a first reactant material configured to produce an observable effect in the indicator region when reacted with a second reactant material. The frangible shells are configured to rupture responsive to an activation action exceeding an activation threshold, releasing the payload from the frangible shells. After being released from the frangible shells, and responsive to the predetermined environmental exposure causing liquefication of the liquefiable material, the first reactant material is exposed to the second reactant material, producing the observable effect. The frangible shells are configured to block the first reactant material from reacting with the second reactant material prior to the activation action. The depressible cover is configured to permit the activation action to be applied to the first plurality of microcapsules by applying a compressive force to the depressible cover.

In an example aspect of the first and second embodiments, when a compressive force having a magnitude which is insufficient to cause plastic deformation to the planarization layer is applied uniformly across the activatable environmental exposure indicator, the planarization layer is configured to be strained within a predetermined range of compressive strain, such that the planarization layer blocks the plurality of microcapsules from rupturing.

In an example aspect of the first and second embodiments, the upper bound of the predetermined range corresponds to a strain at a yield point of the planarization layer.

In an example aspect of the first and second embodiments, the planarization layer is configured such that an upper bound of the predetermined range is a compressive strain between 0 and 0.75.

In an example aspect of the first and second embodiments, the magnitude of the compressive force is at least as great as the activation magnitude.

In an example aspect of the first and second embodiments, the magnitude of the compressive force is at least five times as great as the activation magnitude.

In an example aspect of the first and second embodiments, the depressible cover includes a rough surface aligned with the reservoir, the rough surface configured to facilitate rupturing the frangible shells when the depressible cover applies the activation action to the plurality of microcapsules.

In an example aspect of the first and second embodiments, the activatable environmental exposure indicator further includes a cover layer, overlaying the planarization layer; the cover layer comprising the depressible cover.

In an example aspect of the first and second embodiments, the activatable environmental exposure indicator further includes a cover layer overlaying the planarization layer and comprising a first viewing window through which the indicator region is viewable.

In an example aspect of the first and second embodiments, the technology of the present disclosure may be provided by a plurality of the activatable environmental exposure indicators forming a connected web.

In an example aspect of the first and second embodiments, the connected web is wound onto a roll.

In an example aspect of the first and second embodiments, the planarization layer of each activatable environmental exposure indicator is configured to reduce compressive stresses resulting from internal radial forces of the roll from being transferred to the plurality of microcapsules and rupturing the plurality of microcapsules.

In an example aspect of the first and second embodiments, the compressive stresses resulting from internal radial forces of the roll have a magnitude exceeding an activation pressure threshold.

In an example aspect of the first and second embodiments, the roll is wound with a winding tension having a magnitude defined within a range bounded by 5 pounds-force (lbf) and 50 lbf.

In an example aspect of the first and second embodiments, the activatable environmental exposure indicator further includes a migration component, connectively disposed between the indicator region and the reservoir, and configured such that the payload, after being released from the frangible shells and when the liquefiable material is liquefied, migrates through the migration component.

In an example aspect of the first and second embodiments, the predetermined environmental exposure is an exposure to an environmental condition above a predetermined threshold, and liquefiable material is configured to liquefy responsive to the environmental condition exceeding the predetermined threshold and solidify responsive to the environmental condition receding below the predetermined threshold, such that after the activation action, the payload migrates through the migration component when the environmental condition exceeds the predetermined threshold, and halts migration when the environmental condition recedes below the predetermined threshold.

In an example aspect of the first and second embodiments, the activatable environmental exposure indicator is a time-temperature indicator, configured such that the environmental condition is an ambient temperature and the predetermined threshold is a temperature threshold, such that while the activatable environmental exposure indicator is exposed to a temperature above the predetermined threshold after the payload is released form the frangible shells, the payload migrates along the migration component at a substantially predetermined rate, the liquefiable material resolidifies at a temperature below the predetermined threshold, halting migration of the payload along the migration component.

In an example aspect of the first and second embodiments, the activatable environmental exposure indicator further includes a plurality of indicator regions, each of the plurality of indicator regions disposed at a predetermined location along the migration component, wherein after the activation action, the payload is configured to reach each predetermined location after a respective amount of time for which the environmental condition exceeds the predetermined threshold, and produce the observable effect in a corresponding indicator region.

In an example aspect of the first and second embodiments, the migration component is selected from a group consisting of a wick, a plurality of capillary tubes, a plurality of microchannels.

In an example aspect of the first and second embodiments, the indicator region is selected from a group consisting of a destination wick which is configured to be saturated by the payload when liquefiable material is liquefied, and a destination reservoir into which the payload is configured to flow when the liquefiable material is liquefied.

In an example aspect of the first and second embodiments, the observable effect is a change in an apparent color state of at least a portion of the indicator region resulting from the payload reaching the portion of the indicator region and the payload includes an indicator material configured to change the apparent color state of the portion of the indicator region, the indicator material selected from a group consisting of: a dye, a colorant, an ink, a first reactant configured to react with a second reactant disposed in the indicator region to produce a color state change, a reflective material, a flash material configured to give a bright appearance when illuminated with light of a predetermined wavelength, and combinations thereof.

In an example aspect of the first and second embodiments, the observable effect is a change in an electrical property of the indicator region as measured by a circuit connected to the indicator region, wherein the electrical property is selected from a group consisting of conductivity, resistivity, impedance, capacitance, and inductance.

In an example aspect of the first and second embodiments, the payload includes a plurality of conductive particles configured to change the electrical property of the indicator region, the plurality of conductive particles selected from a group consisting of particles containing copper, particles containing silver, particles containing graphite, particles containing graphene, particles containing graphene oxide, particles containing other functionalized graphenes, particles containing conductive metals, particles containing conductive non-metal materials, electroconductive carbon black, and combinations thereof.

In an example aspect of the first and second embodiments, the liquefiable material comprises a component material selected from a group consisting of: a side-chain crystalline polymer, an alkane, a wax, an alkane wax, esters, other polymeric materials, and combinations thereof.

In an example aspect of the first and second embodiments, the planarization layer is a composite materials including a component material selected form a group consisting of: silicone, plastics, paper, and combinations thereof.

In an example aspect of the first and second embodiments, the liquefiable material is solidified and is configured to prevent the first reactant material from reacting with the second reactant material after the frangible shells are ruptured responsive to the activation action and before the liquefiable material is liquefied.

In an example aspect of the first and second embodiments, the activatable environmental exposure indicator further includes a second plurality of microcapsules disposed in the indicator region, each microcapsule of the second plurality of microcapsules containing the liquefiable material and the second reactant material microencapsulated in a frangible shell, wherein the activatable environmental exposure indicator is configured to react the second reactant material with the first reactant material to produce the observable effect after the frangible shells of the first plurality of microcapsules and the second plurality of microcapsules are ruptured responsive to the activation action and when the liquefiable material is liquefied.

In an example aspect of the first and second embodiments, the second reactant material is disposed in the indicator region, such that the first reactant material is exposed to the second reactant material after the frangible shells of the first plurality of microcapsules are ruptured responsive to the activation action and when the liquefiable material is liquefied.

In an example aspect of the first and second embodiments, the planarization layer is configured so that, when a compressive force is applied uniformly across the activatable environmental exposure indicator and a magnitude of the compressive force is insufficient to plastically deform planarization layer, the depressible cover is not depressed to an extent sufficient to rupture the first plurality of microcapsules.

In an example aspect of the first and second embodiments, the depressible cover includes a rough surface aligned with the first plurality of microcapsules, the rough surface configured to facilitate rupturing the frangible shells when the depressible cover applies the activation action to the first plurality of microcapsules.

In an example aspect of the first and second embodiments, the activatable environmental exposure indicator further includes a cover layer, overlaying the planarization layer; the cover layer comprising the depressible cover.

In an example aspect of the first and second embodiments, the technology of the present disclosure may be provided by an article of manufacture comprising a plurality of the activatable environmental exposure indicators forming a connected web.

In an example aspect of the first and second embodiments, the connected web is wound onto a roll.

In an example aspect of the first and second embodiments, the planarization layer of each activatable environmental exposure indicator is configured to reduce compressive stresses resulting from internal radial forces of the roll from being transferred to the first plurality of microcapsules and rupturing the first plurality of microcapsules.

In an example aspect of the first and second embodiments, the compressive stresses resulting from internal radial forces of the roll have a magnitude exceeding an activation pressure threshold.

In an example aspect of the first and second embodiments, the roll is wound with a winding tension having a magnitude defined within a range bounded by 5 pounds-force (lbf) and 50 lbf.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed technology and explain various principles and advantages of those embodiments.

FIG. 1 illustrates a microcapsule, according to embodiments of the present disclosure.

FIGS. 2A-2B illustrate views of a first embodiment of an activatable environmental exposure indicator having a planarization layer, according to embodiments of the present disclosure.

FIGS. 3A-3C illustrate various configurations of the planarization layer of the activatable environmental exposure indicator of FIGS. 2A-2B.

FIGS. 4A-4B illustrate views of a second embodiment of an activatable environmental exposure indicator having a planarization layer, according to embodiments of the present disclosure.

FIG. 5 illustrates a web of activatable environmental exposure indicators configured as a roll, according to embodiments of the present disclosure.

FIG. 6 illustrates a detailed view of a section of the roll of activatable environmental exposure indicators of FIG. 5, according to embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present technology.

The apparatus and method components have been represented where appropriate by conventional symbols in the drawings, showing only those specific details that are pertinent to understanding the embodiments of the present technology so as not to obscure the disclosure with details that will be readily apparent to those of ordinary skill in the art having the benefit of the description herein.

### DETAILED DESCRIPTION

The technology of the present disclosure is related to an activation platform for environmental indicators, such as peak temperature exposure and time-temperature indicators. Environmental indicators (e.g., indicators incorporating an indicator material that liquefies in response to a predetermined environmental exposure) may be configured to indicate the occurrence of such a predetermined environmental exposure to a host product, e.g., by changing appearance or by changing an electrical property of the indicator which may be detected by an appropriate circuit or computer. Prior to the association between the host product and the indicator, the same level of care may need to be paid to the indicator to prevent an exposure to the same environmental condition which the indicator is configured to indicate, so that the indicator is not spent prematurely and rendered unusable for monitoring the host product. Said differently, if a thermal indicator is to be installed on a host product, the indicator may need to be held below the temperature at which the thermal indicator is configured to indicate prior to installation of the indicator on or with a monitored host product. If a sufficient thermal exposure were to occur prior to pairing with the host product, the indicator would transition to an indicative state prior to installation, and, provided the indicator is an irreversible indicator, the indicator would be expended prior to use. Or part of the indicator life would lost, which might later trigger an indication too soon for a product that was still acceptable. For example, indicators configured for use with refrigerated items, e.g., indicators showing when host products have warmed above a refrigerator temperature, the indicators generally need to be refrigerated prior to being paired with a host product, which results in an additional cost and more complicated inventory management and manufacturing process for the user. Using an indicator that requires an application of an activation action before becoming sensitive to environmental exposure may help avoid these problems. Various types of activable indicators have been previously proposed.

The activatable environmental exposure indicators of the present disclosure employ microcapsules containing a payload. The microcapsules are rupturable by application of an activation action, such as an external application of a compressive or shear force sufficient to rupture the frangible shells of the microcapsules to facilitate release of the payload. In some examples, the application of heat may be provided to weaken the frangible shells and lower an activation threshold of the activation action.

In some embodiments of the present disclosure, the payload contained within the microcapsules is environmentally sensitive, or contains environmentally sensitive materials, which exhibit a phase change responsive to a predetermined environmental exposure. The indicators may be configured, along with, in some embodiments, other materials contained in the payload, to produce or display an observable effect in an indicator region responsive to the phase change resulting from the predetermined environmental exposure. The indicator region may be at or near where the microcapsules are activated, or the released payload may need to flow to another location to provide the indication. The microcapsules are generally configured to prevent this production or display of the observable effect, regardless of exposures to the predetermined environmental exposure, until the microcapsules are ruptured, and the payload is released. In this manner, the indicators are activatable, as the rupturing of the microcapsules may be controlled by a user, such that the indicator does not become environmentally sensitive until the activation action which ruptures the microcapsules is applied.

In many expected use cases of the activatable environmental exposure indicators described herein, many activatable environmental exposure indicators may be used in a given time period, e.g., on a manufacturing or distribution line for host products that need to be monitored, as generally consumable devices, and thus there is a need for bulk supplies of activatable environmental exposure indicators. Various methods of forming activatable environmental exposure indicators are conducive to producing the activatable environmental exposure indicators in the form of a media web, which may be readily configured as a roll (e.g., wound about a spool) of activatable environmental exposure indicators. The activatable environmental exposure indicators are exposed to compressive forces when configured in a roll (e.g., radial forces in the roll) which, in some examples, may be of sufficient magnitude to rupture some of the microcapsules disposed within the indicator, causing premature activation. The activatable environmental exposure indicators of the present disclosure include a planarization layer which is configured to resist such compressive radial forces (e.g., as may be applied to the activatable environmental exposure indicators in a roll configuration) and generally prevent inadvertent rupture of the microcapsules prior to activation. The planarization layer may also help prevent inadvertent activation by other forms of pressure that may also be applied to the indicators without intending to activate them, e.g., passing the indicator media (either a single indicator, or multiple indicators in a web) through a printer, through roller feeds, or applying the indicators as labels to host products or their packaging. The activatable environmental exposure indicators generally include an activation region, where a compressive force localized to the activation region alone transfers a force to the microcapsules, and thus the activation action is applied to the microcapsules, activating the activatable environmental exposure indicator, while compressive forces having similar pressures applied across a broader portion of the media do not trigger the indicator.

The discussion contained in the following detailed description has been organized as follows:
Section I: Some Relevant Materials and Notable Properties Thereof.
Section II: Rupturable Microcapsules
Section III: Embodiments of Activatable Environmental Exposure Indicators.

### Section I: Some Relevant Materials and Notable Properties Thereof

### Liquefiable Materials

Various embodiments of activatable environmental exposure indicators discussed herein utilize a liquefiable material that can be configured to react to an environmental exposure temperature above a predetermined threshold relatively quickly. This is because the liquefiable material of some embodiments is configured or selected to have a sharp melting point, such that liquefaction happens very quickly over a small temperature range. Thus, exposure to a predetermined environmental exposure, e.g., a peak temperature exceeding the melting point of the liquefiable material, causes a quick state change. However, notwithstanding a relatively quick response by the liquefiable material to heat, some indicators discussed herein exhibit a time-dependent response that halts when conditions return below the environmental exposure temperature threshold and resumes again in an additive manner. Again, in some embodiments, this is due to the liquefiable material having a sharp transition between a liquid phase and a solid phase.

For example, where an indicator is configured to signal a response after an exposure of about 30 minutes at and/or above the environmental exposure temperature threshold, a 20-minute exposure will not trigger an observable response in the indicator region, but if the indicator is again exposed to a temperature at and/or above the environmental exposure temperature threshold, a reduced amount of exposure, e.g. about 10 more minutes of exposure may yield a response. In some embodiments as noted above, this behavior is achieved because the liquefiable solid (such as a side-chain crystalline polymer) readily liquefies and solidifies within a narrow temperature range. Once the environmental exposure temperature has been exceeded, a drop in temperature below the environmental exposure will cause almost immediate cessation of the time-dependent response with such materials. The response will resume once the environmental exposure temperature threshold is again exceeded.

As used herein, the terms “predetermined environmental exposure” and “environmental exposure temperature threshold” have an understood meaning in the art and include a temperature, usually a temperature above 0° C. (though temperatures below 0° C. are also contemplated), that can cause damage or harm to a product, such as a food or a vaccine that may require refrigeration to avoid spoilage or maintain efficacy for extended periods. The term “environmental exposure temperature threshold,” then, can include any predetermined temperature that is above a desired storage temperature of a perishable product, though in some cases exposure for short periods of time may not damage or harm a particular product. Thus, some embodiments disclosed herein can be configured to provide signal of exposure to temperatures at and/or above an environmental exposure temperature threshold only after a specified amount of time even if exposure occurs at different times.

In some embodiments, the liquefiable material has a “sharp” liquefaction point, meaning that the transition from solid to liquid happens very quickly over a very small temperature range. In some embodiments, liquefaction temperature and solidification temperature of the liquefiable solid are identical. In some embodiments, the liquefaction and solidification temperatures are within about 0.1° C., within about 0.5° C., within about 1.0° C., within about 1.5° C., within about 2° C., within about 2.5° C., within about 3.0° C., within about 3.5° C., within about 4.0° C., within about 4.5° C., within about 5° C., or within about 10° C. of each other.

As used herein, the term “solid phase” may refer to a material in a non-liquid state such that the material is incapable of fluid flow. In some examples “solid phase” may refer to a gelled state, a highly viscous state, a true solid state, and the like. Similarly, the terms “solidification” and “solidify” are used to describe the transition in which a material not in the solid phase enters the solid phase. The terms “solidification point” and “solidification temperature” are used to describe a temperature, or temperature range, at or in which a material may undergo solidification.

As used herein, the term “liquid phase” is used to describe a state of a material in which the material is capable of fluid flow. Similarly, the terms “liquefaction” and “liquefy” are used to describe the transition in which a material not in the liquid phase enters the liquid phase. The terms “liquefaction point” and “liquefaction temperature” are used to describe a temperature, or temperature range, at or in which a material may undergo liquefaction.

Suitable liquefiable materials include synthetic polymeric materials that are solid below the threshold temperature and are, or can become, a flowing amorphous solid or a viscous liquid when at and/or above a threshold temperature. Such synthetic polymeric materials are liquefiable, as defined herein. Useful synthetic polymers can also be hydrophobic, if desired. Suitable liquefiable materials include side-chain crystallizable polymers (e.g., various methacrylates, such as poly(hexadecylmethacrylate); a polymer or a copolymer having at least one crystallizable side chain selected from the group consisting of a C4-30 aliphatic group; a C6-30 aromatic group; a linear aliphatic group having at least 10 carbon atoms; a combination of at least one aliphatic group and at least one aromatic group, the combination having from 7 carbon atoms to about 30 carbon atoms; a C10-C22 acrylate; a C10-C22 methacrylate; an acrylamide; a methacrylamide; a vinyl ether; a vinyl ester; a fluorinated aliphatic group having at least 6 carbon atoms; and a p-alkyl styrene group wherein the alkyl group has from about 8 carbon atoms to about 24 carbon atoms.).

As used herein, the term “polymer”, and its linguistic variations, refers to copolymers, and higher order polymers, as well as homopolymers, unless the context indicates otherwise, for example, by describing or referencing one or more specific homopolymers.

When solid, the synthetic polymeric material can be crystalline or partially crystalline. Crystalline or partially crystalline synthetic polymeric materials can have desirably sharp transitions from a solid state to a liquid state.

Side chain (liquid) crystalline polymers (abbreviated as SCC hereafter) are particularly suitable liquefiable materials, though other suitable materials such as waxes could readily be used. SCC polymers have a conventional polymer backbone and side chains that can co crystallize. Typically, they are chains that have six or more carbons with a crystallization temperature that is, therefore, adjustable. In some embodiments, the side chains “melt” independently of the main polymer chain so that the phenomenon can be used to release other materials that have been encapsulated within the overall polymer structure. Another advantage of SCC polymers is that their molecular weight and degree of crosslinking can be adjusted to control their physical properties including their permeability and in turn provide an approach to tailor the time delay.

Some examples of SCC polymers include poly(dodecylacrylate), poly(tetradecylacrylate), poly(hexadecylacrylate), poly(octadecylacrylate), copolymer of hexylacrylate and dodecylacrylate, copolymer of hexylacrylate and docosylacrylate, copolymer of decylacrylate and tetradecylacrylate, copolymer of decylacrylate and octadecylacrylate, copolymer of decylacrylate and octadecylacrylate, copolymer of decylacrylate and octadecylacrylate, copolymer of dodecylacrylate and docosylacrylate, copolymer of dodecylacrylate and docosylacrylate, copolymer of dodecylacrylate and docosylacrylate, copolymer oftetradecylacrylate and octadecylacrylate, copolymer oftetradecylacrylate and octadecylacrylate, copolymer oftetradecylacrylate and octadecylacrylate, poly(dodecylmethacrylate), poly(tetradecylmethacrylate), poly(hexadecylmethacrylate), poly(octadecylmethacrylate), copolymer of tetradecylmethacrylate and methyl methacrylate, copolymer of octadecylmethacrylate and methyl methacrylate.

For example, the liquefiable material may be a side-chain crystallizable polymer combined with an alkane wax. Some side-chain crystallizable (SCC) polymers useful in the practice of the present disclosure, alone or in combination, and methods that can be employed for preparing them, are described in O'Leary et al. “Copolymers of poly(n-alkyl acrylates): synthesis, characterization, and monomer reactivity ratios” in Polymer 2004 45 pp 6575-6585 (“O'Leary et al.” herein), and in Greenberg et al. “Side Chain Crystallization of n-Alkyl Polymethacrylates and Polyacrylates” J. Am. Chem. Soc., 1954, 76 (24), pp. 6280-6285 (“Greenberg et al.” herein). The disclosure of each of O'Leary et al. and Greenberg et al. is incorporated by reference herein for all purposes.

Side-chain crystallizable polymers, sometimes called “comb-like” polymers, are well-known and available commercially. These polymers are reviewed in J. Polymer Sci. Macromol. Rev. 8:117-253 (1974), the disclosure of which is hereby incorporated by reference. In general, these polymers contain monomer units X of the formula:

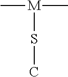

where M is a backbone atom, S is a spacer unit and C is a crystallizable group. These polymers have a heat of fusion (ΔH_{f}) of at least about 20 Joules/g, preferably at least about 40 Joules/g. The polymers will contain about 50 to 100 percent monomer units represented by “X”. If the polymer contains less than 100 percent X, in addition contain monomer units which may be represented by “Y” or “Z”, or both, wherein Y is any polar or nonpolar monomer or mixture of polar or nonpolar monomers capable of polymerizing with X and/or Z, and wherein Z is a polar monomer or mixture of polar monomers. Polar groups, e.g., polyoxyalkylenes, acrylates including hydroxyethylacrylate, acrylamides including methacrylamide-will typically increase adhesion to most substrates. If the polar species “Z” is acrylic acid, it is preferred that it comprise about 1-10 wt. percent of the polymer.

The backbone of the polymer (defined by “M”) may be any organic structure (aliphatic or aromatic hydrocarbon, ester, ether, amide, etc.) or an inorganic structure (sulfide, phosphazine, silicone, etc.), and may include spacer linkages which can be any suitable organic or inorganic unit, for example ester, amide, hydrocar bon, phenyl, ether, or ionic salt (e.g., a carboxyl-alkyl ammonium or sulphonium or phosphonium ion pair or other known ionic salt pair).

The side-chain (defined by ‘S’ and ‘C’) may be aliphatic or aromatic or a combination of aliphatic and aromatic, but must be capable of entering into a crystal line state. Common examples are: linear aliphatic side chains of at least 10 carbon atoms, e.g., C₄-C₂₂ acrylates or methacrylates, acrylamides or methacrylamides, vinyl ethers or esters, siloxanes or alpha olefins; fluorinated aliphatic side-chains of at least 6 carbons; and p-alkyl styrene side-chains wherein the alkyl is of 8 to 24 carbon atoms.

The length of the side-chain moiety is usually greater than 5 times the distance between side-chains in the case of acrylates, methacrylates, vinyl esters, acrylamides, methacrylamides, vinyl ethers and alpha olefins. In the extreme case of a fluoroacrylate alternate copolymer with butadiene, the side-chain can be as little as two times the length as the distance between the branches.

In any case, the side-chain units should make up greater than 50 percent of the volume of the polymer, preferably greater than 65 percent of the volume. Specific examples of side-chain crystallizable monomers are the acrylate, fluoroacrylate, methacrylate and vinyl ester polymers described in J. Poly. Sci 10:3347 (1972); J. Poly. Sci 10:1657 (1972); J. Poly. Sci 9:3367 (1971); J. Poly. Sci 9:3349 (1971); J. Poly. Sci. 9:1835 (1971); J.A.C.S. 76:6280 (1954); J. Poly, Sci 7:3053 (1969); Polymer J. 17:991 (1985), corresponding acryl amides, substituted acrylamide and maleimide polymers (J. Poly. Sci: Poly. Physics Ed. 18:2197 (1980)); polyalphaolefin polymers such as those described in J. Poly. 5,156,911 7 Sci. Macromol. Rey, 8:117-253 (1974) and Macromolecules 13:12 (1980), polyalkylvinylethers, polyalkylethylene oxides such as those described in Macromolecules 13:15 (1980), alkylphosphazene polymers, polyamino acids such as those described in Poly. Sci. USSR 21:241, Macromolecules 18:2141, polyisocyanates such as those described in Macromolecules 12:94 (1979), polyurethanes made by reacting amine- or alcohol-containing monomers with long-chain alkyl isocyanates, polyesters and polyethers, polysiloxanes and polysilanes such as those described in Macromolecules 19:611 (1986), and p-alkylstyrene polymers such as those described in J.A.C.S. 75:3326 (1953) and J. Poly. Sci 60:19 (1962). Of specific utility are polymers which are both relatively polar and capable of crystallization, but wherein the crystallizing portion is not affected by moisture. For example, incorporation of polyoxyethylene, polyoxy propylene, polyoxybutylene or copolyoxyalkylene units in the polymer will make the polymer more polar.

In a particularly preferred embodiment herein, in the above structure, —C is selected from the group consisting of —(CH₂)—CH₃ and —(CF₂)ₙ—CF₂H, where n is an integer in the range of 8 to 20 inclusive, —S— is selected from the group consisting of —O—, —CH₂—, —(CO)—, —O(CO)— and —NR— where R is hydrogen or lower alkyl (1-6C), and -M- is —[(CH₂)ₘ CH]— where m is 0 to 2.

Typical “Y” units include linear or branched alkyl or aryl acrylates or methacrylates, alpha olefins, linear or branched alkyl vinyl ether or vinyl esters, maleicesters or itaconic acid esters, acrylamides, styrenes or substituted styrenes, acrylic acid, methacrylic acid and hydrophilic monomers as detailed in WO84/0387, cited supra.

Some useful side-chain crystallizable polymers, and monomers for preparing side-chain crystallizable polymers, are also available from commercial suppliers, for example, Scientific Polymer Products, Inc., Ontario, N.Y., Sigma-Aldrich, Saint Louis, Mo., TCI America, Portland Oreg., Monomer-Polymer & Dajac Labs, Inc., Trevose, Pa., San Esters Corp., New York, N.Y., Sartomer USA, LLC, Exton Pa., and Polysciences, Inc.

Other suitable liquefiable materials may be alkane waxes alone, without SCCs, or alkane waxes blended with SCCs.

### Frangible Shells

Various embodiments of activatable environmental exposure indicators and activation indicator components discussed herein utilize microcapsules having frangible shells, which are employed to microencapsulate several other materials (e.g., liquefiable materials, indicator materials, thermally expansive materials, thermally expandable microspheres) forming a microcapsule. The frangible shells are rupturable, e.g., the frangible shells rupture and release the payload when subjected to an activation action.

The microcapsules may be any size, but in one such embodiment, has an outer diameter length between 20-1000 μm. The frangible shell may be any size smaller than or equal to the outer diameter of the microcapsule. The microcapsules can have a thickness between 5 to 25 micrometers (μm). The payload ratio, or the ratio of the total weight of the payload within the microcapsule to the entire weight of the microcapsule including the contents contained within the microcapsule, can range from 50 percent to 90 percent. A variety of microcapsule frangible shell materials may be chosen, depending on the application, the mode of rupture, and the nature of the contents of the microcapsule. In general, the microcapsules should resist the passage, whether by flow, diffusion, or migration, of the contents of the microcapsule prior to rupturing.

For example, the frangible shell may be formed in whole or in part by a wax, e.g., an alkane wax, or other acid resistant compound having a relatively high melting point, e.g., fatty acid amide, an ester or Elvax EVA resin. For example, the melting point may be in a range of about 50 degrees Celsius (C) to about 300 degrees C., from about 100 degrees C. to about 300 degrees C., from about 150 degrees C. to about 300 degrees C., from about 200 degrees C. to about 300 degrees C., from about 250 degrees C. to about 300 degrees C. Generally, the shell should have a higher melting point than the maximum temperature the microcapsule is expected to be exposed to in normal use, to prevent it from rupturing or melting prematurely.

In another example, the frangible shell may be formed in whole or in part by a polymer coating having a high glass transition temperature (T_{g}) e.g. Polysulfone. For example, the glass transition temperature may be in a range of about 50 degrees C. to about 300 degrees C., from about 100 degrees C. to about 300 degrees C., from about 150 degrees C. to about 300 degrees C., from about 200 degrees C. to about 300 degrees C., from about 250 degrees C. to about 300 degrees C. For example, Polysulfone, with a T_{g} of about 190 C may be used. In additional examples, the microcapsules 100 may be one of Styrene Maleic Anhydride (SMA), Polyphenylene Ether (PPE), Cellulose Acetate, Cellulose Diacetate, Polyacrylate, Polyamide, Polycarbonate, polyether ether ketone, Polyether Sulfone, PET, PFA, polymethyl methacrylate (PMMA) or Polyimide.

In another example, the frangible shell may be formed in whole or in part by a low molecular weight polymer gel having a high melting point, e.g., fatty acid amide, an ester or Elvax EVA resin. For example, the melting point may be in a range of about 100 degrees C. to about 300 degrees C., from about 150 degrees C. to about 300 degrees C., from about 200 degrees C. to about 300 degrees C., from about 250 degrees C. to about 300 degrees C. Additionally, in some examples, the polymer gel has a molecular weight in a range from about 1 grams per mole (g/mol) to 100,000 g/mol, from about 3,500 g/mol to 6,000 g/mol and from about 200 g/mol to 2,000 g/mol.

Alternatively, the frangible shell may be formed in whole or in part by a gel, gelatin, protein, polyurea formaldehyde, polymelamine formaldehyde, wax material, melamine, or an emulsion. The microcapsules may be available in wet and dry formulations. Polymelamine and polyurea formaldehyde can both be used for encapsulations via interfacial polymerization, which uses two immiscible phases. Once separated in the same vessel, a reaction is initiated at the interface of the two immiscible phases in the presence of an initiator and the material to be encapsulated. As polymerization occurs, microcapsules form around the core material. The microcapsule releases the contents of the microcapsule upon rupturing.

The microcapsule is initially in an unruptured form, capable of being configured to transition to a ruptured form through exposure to an activation action, e.g., the application of heat, pressure, and/or a combination of heat and pressure exceeding a predetermined threshold. In the unruptured form, the frangible shell of the microcapsule maintains separation between the contents of the microcapsule and any external environmental stimuli and/or contains a phase change of the contents of the microcapsule in response to any external environmental stimuli.

The frangible shells may be “ruptured” (e.g., broken, disengaged, dissolved, etc.) by applying an activation action to the microcapsule. In some examples “applying an activation action” may constitute exposing the microcapsule to an activation action, such as a pressure stress or a thermal stress, or a combination thereof. The activation action may directly or indirectly cause the frangible shell to fracture, melt, break, dissolve, sublime, become porous, or otherwise disengage, allowing the release of the contents of the frangible shell. In some examples, the frangible shells may be ruptured by one or more activation actions. In some such examples, simultaneous activation actions may be applied to rupture the microcapsules. In other such examples, ordered or non-ordered sequential activation actions may be applied to rupture the microcapsules.

The frangible shells may have one or more of various rupture modes (e.g., or weaking modes), to which the activation action or actions correspond. Each activation action may be configured to have a predetermined activation threshold at which the microcapsule is configured to rupture. In some examples, each activation action may be configured to have a predetermined activation threshold at which the frangible shell of the microcapsule is weakened (e.g., but not ruptured) to a predetermined extent, such that the predetermined activation threshold of a second activation action necessary to rupture the microcapsule is lowered (when compared to the predetermined activation threshold of the second activation alone). Said differently, a first activation action may lower an energy requirement of a second activation action in order to activate the microcapsule.

A first rupture mode is rupture or weaking by means of externally applied pressure. In some examples, the microcapsules may be ruptured by a source of external pressure, where the activation action is an exposure to a compressive or shearing force. The frangible shells may be configured such that the predetermined activation threshold corresponds to a compression stress or a shear stress of sufficient magnitude to rupture the frangible shell. In some examples, the predetermined stress threshold is a compressive stress or a shearing stress exceeding about 0.1 pounds per square inch (psi), a compressive stress or a shearing stress exceeding about 0.5 psi, a compressive stress or a shearing stress exceeding about 1 psi, a compressive stress or a shearing stress exceeding about 2 psi, a compressive stress or a shearing stress exceeding about 5 psi, a compressive stress or a shearing stress exceeding about 10 psi, or a compressive stress or a shearing stress exceeding about 15 psi. The activation stress ranges given are purely exemplary and the microcapsules can be formed to respond to other stress ranges.

Another rupture mode is rupture or weaking by means of heat exposure. In some examples, the microcapsules may be ruptured or weakened by a source of heat, where the activation action is an exposure to a temperature configured to melt, degrade, decrease the structural integrity of, or otherwise disengage the frangible shell. In some such examples, the predetermined activation threshold may correspond to a temperature exceeding about 35 degrees C., a temperature exceeding about 40 degrees C., a temperature exceeding about 45 degrees C., a temperature exceeding about 50 degrees C., a temperature exceeding about 55 degrees C., a temperature exceeding about 60 degrees C., a temperature exceeding about 65 degrees C., a temperature exceeding about 70 degrees C., a temperature exceeding about 75 degrees C., a temperature exceeding about 80 degrees C., a temperature exceeding about 85 degrees C., a temperature exceeding about 90 degrees C., a temperature exceeding about 95 degrees C., and a temperature exceeding about 100 degrees C. The activation heat ranges given are purely exemplary and the microcapsules can be formed to respond to other temperature ranges.

In some such examples, activation may be achieved by applying a high temperature for a very short interval, e.g., a few milliseconds. For example, the mass or heat of fusion of the indicator may be much greater than the mass or heat of fusion of a barrier that needs to be removed, allowing a short exposure to high temperature to remove or alter the microcapsule without significantly affecting a thermally sensitive payload contained in the microcapsule.

In some examples in which two activation actions are required to rupture the microcapsules, the activation actions may employ the same rupture modes, enacted at different thresholds, or different rupture modes.

The activation pressure and temperature ranges given are purely exemplary and other ranges may be sufficient to rupture or weaken the frangible shells, where such pressure ranges may vary based on a composition of the frangible shell, a thickness of the frangible shell, a ratio between the shell thickness or weight to volume or weight of the indicator material, a diameter of the microcapsules, a temperature applied to the shells, etc.

According to some embodiments, the frangible shell is electrically nonconductive, insulative, resistive, or otherwise resists, and may substantially prevent the conduction of electricity through the microcapsule.

### Indicator Materials

According to some embodiments, the microcapsules disclosed herein contain a payload including both a liquefiable material and an accompanying indicator material. When in the solid state, the liquefiable material may substantially prevent movement, migration or diffusion of the indicator material through the liquefiable material. When the liquefiable material is in the liquid state, the indicator material may be able to migrate, move or diffuse through the liquefiable material, and in some examples the indicator material is transportable by the liquefiable material.

Generally, an indicator material produces or facilitates the production of a detectable indication, e.g., a change in color state or electrical property, in response to a predetermined environmental stimulus, e.g., heating above a threshold temperature. When combined with a liquefiable material, the indicator material is configured to produce, either alone or in combination with other elements, a detectable indication when the liquefiable material liquefies (e.g., in response to a predetermined environmental exposure).

The simplest form of indicator material may be a colorant, dye, or other material that may be transported by the liquefiable material.

Some embodiments of indicator materials discussed here utilize two or more compounds capable of reacting with each other to yield a color change. In some examples, the two or more reactants may be separated within a single microcapsule and prevented from mutual contact by a liquefiable material in a solid state. In some embodiments two or more reactants may be and contained in distinct microcapsules, which substantially prevent the compounds from interacting prior to the rupturing of the microcapsules. Alternatively, a first of the compounds may be contained in the microcapsules, and a second of the compounds may be disposed in an indicator region of the indicator.

Used in combination with the liquefiable material, in some embodiments, are color-reacting materials, such as two reactants kept separate by the microcapsules but allowed to react with each other after rupture or migration. Dyes can also be dissolved in such liquefiable materials to provide an intense color. In some embodiments, the color-reacting materials, or color-forming reactants, produce a distinct color change or change in opacity when brought into contact with each other. A common example is the use of a leuco dye system.

When the reactants come into contact, the appearance change of the indicator may be to go from clear to black, from clear to a dark color, from a light color to a dark color, from a light color to black, etc. In some embodiments, a background is visible through the liquefiable layer(s) prior to the reaction, thereby indicating that the predetermined temperature threshold and required exposure period have not yet been satisfied. The background may include words, numbers, or a pattern, or may simply comprise a color that is easily obscured by the color-forming reaction of the reactants. In some embodiments, a pattern on the background is at least partially obscured by the light color of the liquefiable layer(s), and the pattern becomes more visible after the color-forming reaction. For example, if the pattern is formed with an ink having a color similar to the color of the pre-reacted reactants, a color change produced by the interaction of the color-forming reactants may render the pattern more visible.

In some examples, the liquefiable material may also serve as an indicator material. Some liquefiable materials exhibit visibly detectable changes when undergoing a phase change, such as changes in opacity. Some indicators of the present disclosure may rely on such visibly detectable changes of the liquefiable material as the production of the observable effect, and include components configured to visually emphasize the visibly detectable change when the change occurs.

Some embodiments discussed herein utilize conductive particles which, when employed in tandem with a liquefiable material, may be held separately from one another when the liquefiable material is in the solid phase, and be configured to form an electrical connection between two electrodes when the liquefiable material is in the liquid phase. Thus, by measuring the conductivity between the two electrodes, the state of the liquefiable material can be determined, or rather, an exposure of the liquefiable material to the predetermined environmental exposure may be confirmed. According to some embodiments, the conductive particles may include particles of conductive metals, such as copper, silver, gold, aluminum, zinc, tin, similar metals, and alloys thereof. The conductive particles may also include particles of graphene, graphite, electroconductive carbon black, graphene oxides, and other functionalized graphenes, and particles containing conductive non-metals. The conductive particles may be formed in whole or in part by any electrically conductive substance or material operable to be particlized to a sufficient size to fit within the shell of a microcapsule.

Some embodiments of indicator materials discussed herein utilize colored or bright materials, such as dyes, flash materials, and other colorants. In some examples, liquefaction of the liquefiable material may result in a change in opacity of the liquefiable material, which may reveal or obscure the indicator material. In some examples, the liquefiable material may transport the indicator material from a non-viewable or concealed location to a viewable location when in the liquid state.

### Section II: Rupturable Microcapsules

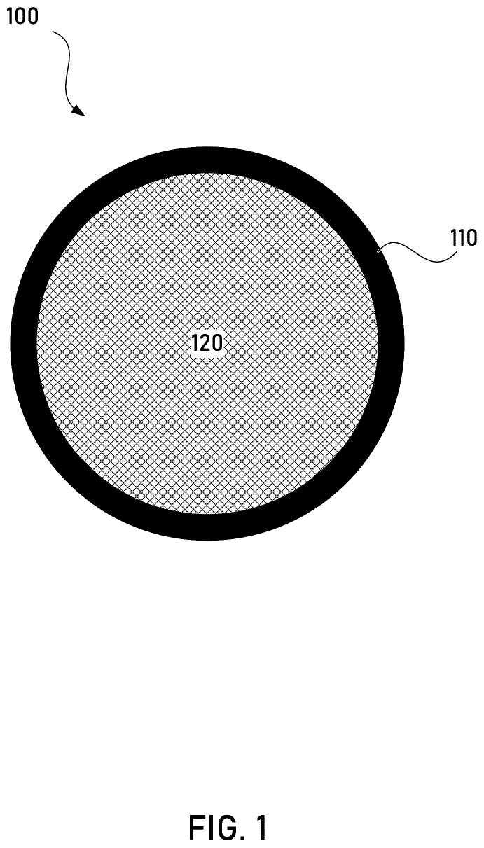

FIG. 1 illustrates a cross-sectional view of a microcapsule 100, as may be used in an activatable indicator, according to embodiments of the present disclosure.

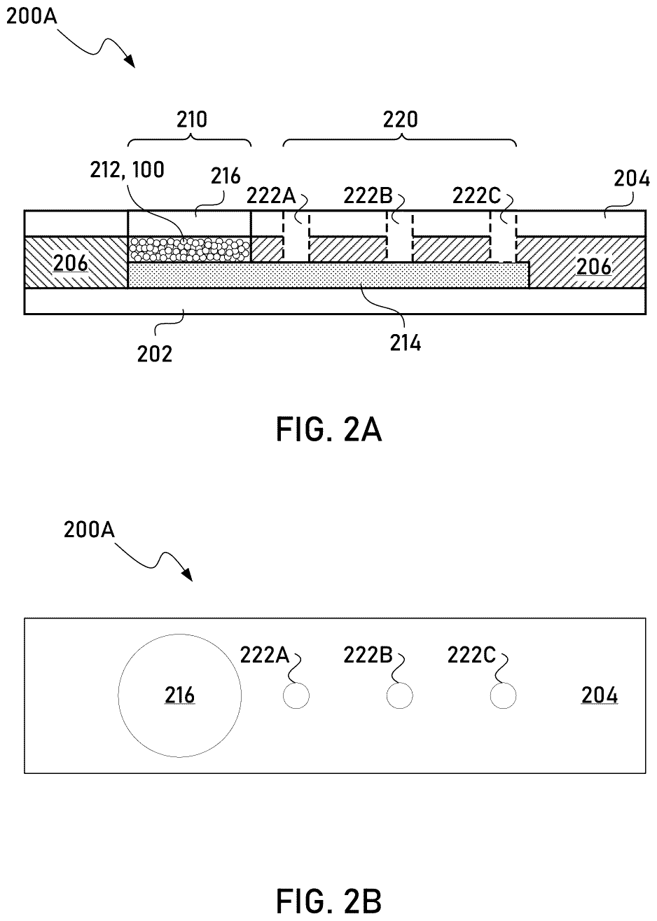

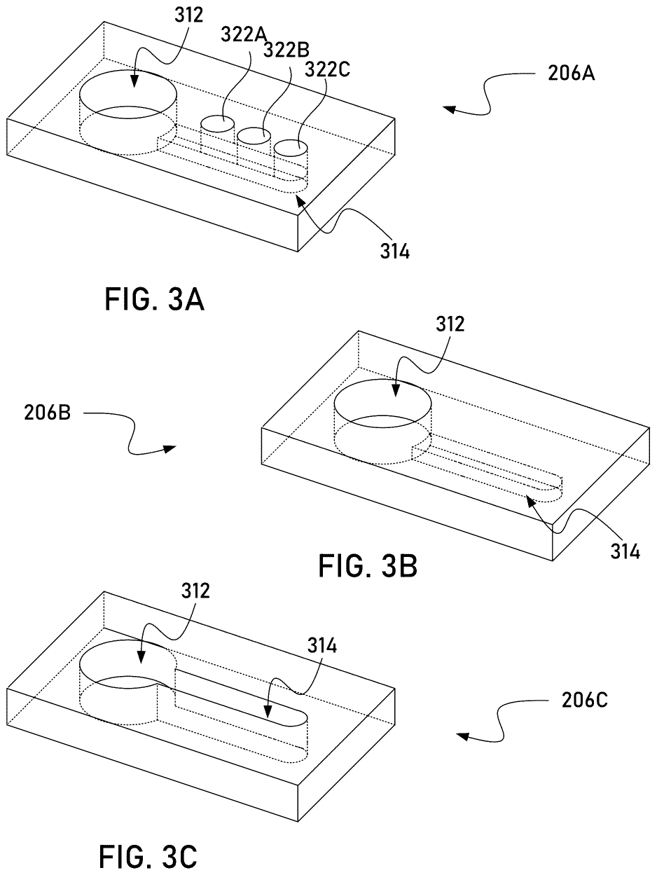

The microcapsule 100 includes a frangible shell 110. The frangible shell 110 contains a payload 120. In some examples, the payload 120 includes a liquefiable material combined with an indicator material, which may be configured to produce an effect (e.g., either alone or in tandem with elements of an indicator (see FIGS. 2A-3B)) when the liquefiable material transitions from a solid phase to a liquid phase.

With respect to the payload 120, in some examples, the liquefiable material forms a solid matrix when in the solid phase, such that indicator material is embedded within a matrix formed by the liquefiable material. When the liquefiable material liquefies, the liquefiable material may act as a transport material with respect to the indicator material. When liquefiable material liquefies, the indicator material is released from the matrix and movement of the indicator material is facilitated through the liquefied liquefiable material. Furthermore, the when the liquefied liquefiable material is acted upon (e.g., by wicking action, capillary action, gravity or other forces) and compelled to motion, the liquefied liquefiable material may transport the indicator material as the liquefiable material moves.

In the present disclosure, the payload 120 includes a sufficient proportion of the liquefiable material that when the liquefiable material liquefies, the payload 120 as a whole, notwithstanding suspended or contained solids (e.g. indicator materials) being contained therein, substantially acts as a liquid. Thus, throughout the disclosure the payload 120 may be said to liquefy. It is understood that reference to the payload 120 liquefying or being liquefied (e.g., and other variations across parts of speech) indicates only that the liquefiable material within the payload 120 is liquefied. Such language does not imply or indicate that the payload 120 does not contain or include non-liquid materials, nor does such language indicate that any material within the payload 120 apart from the liquefiable material is necessarily liquefied.

According to some embodiments, the liquefiable material of the payload 120 may be one of, or a combination of the liquefiable materials listed above in Section I. Furthermore, the indicator material may be one of, or a combination of, the indicator materials listed above in Section I. Moreover, payload 120 materials (e.g., liquefiable materials and indicator materials) may be selected according to other features or design constraints of the indicators with which the microcapsules 100 are to be employed. Some liquefiable materials may exhibit advantageous properties with some wicks, some indicator materials, some temperature ranges, and so forth.

The microcapsule 100 may be any size, but in one such embodiment, has an outer diameter length between 20 to 1000 micrometers (μm). The frangible shell 110 may be any size smaller than or equal to the outer diameter of the microcapsule 100. The frangible shell 110 can have a thickness of between 5 to 25 μm. The ratio of the total weight of the contents (e.g. thermally expandable microsphere, payload 120) within the microcapsule 100 to the entire weight of the microcapsule 100 including the contents contained within the microcapsule 100, can range from 50 percent to 90 percent. A variety of frangible shell 110 materials may be chosen, depending on the application, and the nature of the payload 120 of the microcapsule 100. In general, the frangible shells 110 should resist the passage, whether by flow, diffusion, or migration, of the payload 120 of the microcapsule 100, prior to activation.

Generally speaking, the microcapsule 100 is configured to be activated responsive to an application of an activation action, or in some examples, two activation actions. When activated, the frangible shell 110 of the microcapsule 100 is disengaged, such that the payload 120 of the microcapsule 100 is exposed to the environment. When the payload 120 is exposed to the environment, an exposure to the predetermined environmental exposure causes the payload 120 to transition to the liquid state. In this manner, when the payload 120 is exposed to the environment, the payload 120 is primed to begin sensing, or is environmentally sensitive.

The microcapsule 100 may be “activated” or ruptured by exposing the microcapsule 100 to an activation action (e.g. activation stress, activation exposure, activation event, etc.) exceeding a predetermined activation threshold. The activation action may cause the microcapsule 100 to fracture, melt, break, dissolve, sublime, become porous, or otherwise disengage, allowing the release of the contents of the microcapsule 100.

In some cases, pressure contributes to the activation, e.g., by breaking microcapsules 100, either alone or in combination with elevated temperature. In such embodiments, the activation action is a compressive stress, or a shearing stress, where the predetermined activation threshold is a stress exceeding about 0.1 pounds per square inch (psi), a stress exceeding about 0.5 psi, a stress exceeding about 1 psi, a stress exceeding about 2 psi, a stress exceeding about 5 psi, a stress exceeding about 10 psi, or a stress exceeding about 15 psi.

Generally, prior to activation, the frangible shells 110 are configured to block the payload 120 from flowing, diffusing, or otherwise being released from the microcapsule 100, whether the payload 120 is liquefied or solidified.

### Section III: Embodiments of Activatable Environmental Exposure Indicators

### Activatable Environmental Exposure Indicator: Time-Temperature Indicator

FIGS. 2A-2B illustrate a first embodiment of an activatable environmental exposure indicator 200A (e.g., time-temperature indicator), according to embodiments of the present disclosure. The activatable environmental exposure indicator 200 includes a substrate 202, a wick 214, and a plurality of activatable microcapsules 100, each microcapsule 100 including a payload 120 microencapsulated in a frangible shell 110. The plurality of microcapsules 100 is disposed adjacent to the wick 214, and generally contained in a reservoir 212. The activatable environmental exposure indicator 200 further includes a planarization layer 206 which overlays the substrate 202 and, in some examples, surrounds or otherwise defines the reservoir 212 in which the microcapsules 100 are disposed. As illustrated, the activatable environmental exposure indicator 200 includes a cover layer 204 which overlays the planarization layer and 206 and defines viewing windows 222A-C, which are also defined through the planarization layer 206.

The activatable environmental exposure indicator 200 defines an activation region 210 and an indicator region 220. Generally, application of an activation compressive force to the activation region 210 results in the rupture of the plurality of microcapsules 100, and the release of the payload 120 contained therein. Responsive to a predetermined environmental exposure occurring after the application of the activation compressive force, the payload 120 produces an observable effect in the indicator region 220.

The activation compressive force activates the activatable environmental exposure indicator 200 to begin environmental sensing (e.g., by releasing the payload 120 from the microcapsules 100). In some examples, the activation compressive force must be applied exclusively to the indicator region 220 and have a magnitude exceeding a predetermined threshold, referred to as the activation magnitude, for activation of the activatable environmental exposure indicator 200 to occur. The activation magnitude is the minimum magnitude of a force that must be applied to the activation region 210 such that the activation action is applied to the microcapsules 100. The activation compressive force provides sufficient pressure on the microcapsules 100 to rupture the microcapsules 100, generally between 0.1 and 15 psi. As such the activation magnitude may be defined in a range from about 0.1 lbf to about 50 lbf.

Generally, the planarization layer 206 is configured to resist compressive forces applied to the activatable environmental exposure indicator 200A which are not exclusively localized to the activation region 210. In this manner, a delocalized compressive force applied to the activatable environmental exposure indicator 200A, (e.g., such as may be applied by a stamp, a roller, or a heavy object) does not impact the activatable environmental exposure indicator 200A in a manner that results in the rupture of the microcapsules 100.

The following discussion of certain features of the planarization layer 206 include references to stress, strain and strength. As used herein, stress refers to the force per unit area a material or object is subjected to. Strain is a measure of deformation resulting from stress, given as a ratio of the change in a dimension of the object (e.g., such as thickness) relative to the dimension before the stress was applied. Strains are categorized in terms of elastically deforming strains, in which the material will return to an unstrained state when the stress is no longer applied, and plastically deforming strains, in which the material will remain in a strained state after the stress is no longer applied (e.g., the material is permanently deformed). The strength of a material is the maximum stress a material can withstand prior to exhibiting strain.

In some embodiments, combinations of several features of the planarization layer 206 can be specified to prevent or mitigate inadvertent activation of the microcapsules 100. Such features include the elasticity of the planarization layer 206, the thickness of the planarization layer 206 and compressive strength of the planarization layer 206.

In some examples, the planarization layer 206 may be configured such that the compressive strength of the planarization layer 206 is greater than the stresses resulting from compressive forces within expected ranges (e.g., where the compressive force is insufficient to plastically deform, or permanently damage the planarization layer 206). In such examples, the activatable environmental exposure indicator 200 is generally non-flexible, and does not deform prior to the compressive force exceeding the compressive strength of the material (e.g., which would be considered beyond expected ranges). As such, the planarization layer 206 may have a thickness which is just enough to accommodate the reservoir 212 and other features, as no deformation is expected in order to prevent inadvertent activation of the microcapsules 100. In some examples, the planarization layer 206 can have a compressive strength between 0.1 psi and 1 psi, 2 psi and 8 psi, 8 psi and 15 psi, 15 psi to 20 psi, or greater than 20 psi.

In some examples the planarization layer 206 may be configured or selected so as to exhibit elastic strains to a predetermined degree responsive to the stresses resulting from compressive forces within expected ranges. In such examples, the activatable environmental exposure indicator 200 may exhibit varying degrees of flexibility in accordance with the elasticity of the material. The more elastic the material, the more strain (e.g., deformation) is expected in order to prevent inadvertent activation of the microcapsules 100. As such, when the planarization layer 206 is more elastic, the thickness may be increased to provide more room (e.g., in the reservoir 212) to allow for deformation without inadvertently rupturing the microcapsules. Conversely, when the planarization layer 206 is more rigid, the thickness may be reduced as less room is required. In various examples, the planarization layer 206 may be configured to exhibit strains within a predetermined range of compressive strains of about 0, about 0.01, about 0.1, about 0.25, about 0.5, or up to about 0.75 responsive to the compressive stresses while preventing inadvertent activation of the microcapsules 100. In various examples, the maximum strain, or an upper bound on the predetermined range of compressive strains may be the yield point of the material from which the planarization layer 206 is constructed.

Generally, the activatable environmental exposure indicator 200 may be configured to resist compressive forces and prevent or mitigate inadvertent activation of the microcapsules 100 as a result thereof. The activatable environmental exposure indicator 200 may be configured to resist compressive forces having a magnitude that is at least as great as the specified activation magnitude. The activatable environmental exposure indicator 200 may be configured to resist compressive forces having magnitudes which are at least as great as twice the specified activation magnitude, at least as great as five times the specified activation magnitude, or greater than ten times the specified activation magnitude.

In some examples, the thickness of the planarization layer 206 may be correlated to, or dependent on the flexure characteristics of the planarization layer 206. Assuming a substrate 202 of fixed dimensions, a thinner planarization layer 206 will result in greater flexibility of the activatable environmental exposure indicator 200A (e.g., for rolling into a spool) and a thicker planarization layer 206 can result in a more rigid and less flexible activatable environmental exposure indicator 200A. A thicker planarization layer 206 may allow for a greater quantity of microcapsules 100 to be housed by the reservoir 212 and may also provide greater resistance to delocalized compressive forces. For example, a smaller roll of activatable environmental exposure indicators 200A, having a spool of a comparatively small diameter may be best suited by activatable environmental exposure indicators 200A having a thinner planarization layer 206, as the smaller roll requires greater flexure to wind about a smaller diameter spool, and will experience weaker compressive forces as a result of being wound into the roll. Conversely, a larger roll of activatable environmental exposure indicators 200A, having a spool of a comparatively large diameter may be best suited to activatable environmental exposure indicators 200A having a thicker planarization layer 206, as the larger roll experiences greater compressive forces, and requires less flexure to wind about a larger diameter spool. In this manner, the planarization layer 206 may be selected, configured, or otherwise tailored to meet needs of a particular use-case.

Generally, the planarization layer 206 is flexible enough to form a curve (e.g., when flexed) having a central angle between 0 and 90 degrees.

According to some embodiments, the planarization layer 206 is formed of one or more materials, including silicone, rubber, plastics, paper, and combinations thereof.

The activation region includes a depressible cover 216 which is configured to translate or deform upon receiving the localized compressive force (the localized compressive force being localized to the activation region 210, or more specifically to the depressible cover 216) such that the depressible cover transfers a compressive stress to the microcapsules 100, causing the frangible shells to rupture, releasing the payload 120. The depressible cover 216 is aligned with the reservoir, such that the compressive force directly transfers the compressive stress to the microcapsules 100 in the reservoir 212. The microcapsules 100 are configured to rupture when the compressive stress transferred to the microcapsules exceeds an activation pressure threshold. In various embodiments, the activation pressure threshold may be about 0.1 psi, about 0.5 psi, about 1 psi, about 2 psi, about 10 psi, about 15 psi. The provided range is purely exemplary, as it is understood that the microcapsules 100 may be configured to rupture responsive to many activation pressure thresholds.

As illustrated, the wick 214 extends along the substrate 202 and is extends into the reservoir 212. In some examples, the wick 214 may extend along the substrate 202 up to the reservoir 212, and the microcapsules 100 disposed directly on the substrate 202. Generally, the wick 214 is in fluid communication with the reservoir 212, such that the payload 120, when released from the microcapsules 100 and liquefied, flows into the wick 214.

FIGS. 3A-3C illustrate various configurations of the planarization layer 206. FIG. 3A illustrates a first configuration of the planarization layer 206A including a reservoir relief 312, a wick relief 314, and relief holes 322A-C aligned with the viewing windows 222A-C. The reservoir relief 312 may define the reservoir 212 or house the reservoir 212 in examples where the reservoir 212 is a separable component. The wick relief 314 is defined along a surface of the planarization layer 206 which configured to overlay the substrate 202. The relief holes 322A-C are defined into a surface opposite to the surface into which the wick relief 314 is defined, and the relief holes 322 A-C are inlaid through the planarization layer 206 to the wick relief 314. In embodiment of the activatable environmental exposure indicator 200A employing the first configuration of the planarization layer 206A, the wick 214 may be disposed in the wick relief 314, such that the wick 214 is enveloped between the planarization layer 206 and the substrate 202.

FIG. 3B illustrates a second configuration of the planarization layer 206B, including a wick relief 314 and a reservoir relief 312. The reservoir relief 312 may define the reservoir 212 or house the reservoir 212 in examples where the reservoir 212 is a separable component. The wick relief 314 is defined along a surface of the planarization layer 206 which configured to overlay the substrate 202, such that the wick 214 is enveloped between the planarization layer 206 and the substrate 202. In such an example, the planarization layer 206 may be constructed of a transparent material, such that the wick is viewable through the planarization layer 206B. Alternatively the planarization layer 206B may be inverted, such that the wick 214 is enveloped between the planarization layer 206 and the cover layer 204, the cover layer 204 defining the viewing windows 222A-C, such that the wick 214 is viewable to a user.

FIG. 3C illustrates a third configuration of the planarization layer 206 including a reservoir relief 312 and a wick relief 314. The wick relief 314 is defined between opposing surface of the planarization layer 206C, such that when the wick 214 is installed in an activatable environmental exposure indicator 200A employing the third configuration of the planarization layer 206C, the wick 214 is bounded by the substrate 202 in a first plane, the cover layer 204 in a second plane, and by the planarization layer 206 in the remaining planes.

Returning to FIGS. 2A-2B, the activation region includes a depressible cover 216 which is configured to translate or deform upon receiving the localized compressive force (the localized compressive force being localized to the activation region 210, or more specifically to the depressible cover 216) such that the depressible cover transfers a compressive stress to the microcapsules 100, causing the frangible shells to rupture, releasing the payload 120. The depressible cover 216 is aligned with the reservoir, such that the compressive force directly transfers the compressive stress to the microcapsules 100 in the reservoir 212. In some examples, the depressible cover 216 may be unified with one or both of the planarization layer 206 and the cover layer 204.

The microcapsules 100 are configured to rupture when the compressive stress transferred to the microcapsules exceeds an activation pressure threshold. In various embodiments, the activation pressure threshold may be about 0.1 psi, about 0.5 psi, about 1 psi, about 2 psi, about 10 psi, about 15 psi. The provided range is purely exemplary, as it is understood that the microcapsules 100 may be configured to rupture responsive to many activation pressure thresholds.

After being released from the frangible shells 110, and responsive to a predetermined environmental exposure, the payload 120 liquefies and migrates into and along the wick 214. The payload 120 is configured to produce an observable effect in the portions of the wick 214 through which the payload 120 has migrated.

The activatable environmental exposure indicator 200A is a time-dependent indicator, and the predetermined environmental exposure to which the activatable environmental exposure indicator 200A responds is an environmental exposure exceeding (e.g., positively or negatively) a predetermined exposure threshold, and remaining in excess of the predetermined exposure threshold for at least a predetermined period of time.

In some examples, the predetermined environmental exposure may be an ambient temperature excursion above a predetermined temperature threshold for at least a predetermined amount of time, an ambient temperature excursion below a predetermined temperature for at least a predetermined amount of time, cumulative exposure to an ambient temperature over a time period above a predetermined threshold for at least a predetermined amount of time, an exposure to a particular chemical for a predetermined period of time, an oxygen exposure lasting for a predetermined period of time, an ammonia exposure lasting for a predetermined period of time, an exposure to a particular chemical above a threshold concentration for at least a predetermined period of time, an exposure to a particular chemical above the threshold concentration for at least a predetermined amount of time, an exposure to at least a predetermined amount of radiation of a particular type for at least a predetermined amount of time, a predetermined electromagnetic exposure for at least a predetermined amount of time, and an exposure to a humidity level above a predetermined threshold for at least a predetermined amount of time.

In some examples, after the application of the activation action, (e.g., after the frangible shells 110 of the plurality of microcapsules 100 are ruptured and the payload 120 is released therefrom), and responsive to the predetermined environmental exposure, the payload 120 liquefies and migrates into the wick 214. As the activatable environmental exposure indicator 200A is configured to indicate an amount of time for which the activatable environmental exposure indicator 200A is exposed to an environmental condition exceeding a predetermined threshold.

The liquefied payload 120 migrates through the wick 214 at a substantially predetermined rate, such that a distance through the migration region that the liquefied payload 120 has migrated corresponds to an amount of time for which the activatable environmental exposure indicator 200A has been exposed to the environmental condition exceeding the predetermined threshold. The payload 120 and the wick 214 may be configured to indicate any amount of time that the activatable environmental exposure indicator 200A is exposed to the environmental condition exceeding the predetermined threshold, but as non-limiting examples, the activatable environmental exposure indicator 200A may be configured to indicate cumulative exposure durations of about 10 minutes, about 30 minutes, about 1 hour, about 3 hours, about 10 hours, or of about 24 hours.

The liquefiable material of the payload 120 may also be configured to solidify and halt migration of the payload 120 when the environmental condition no longer exceeds the predetermined threshold (e.g., recedes below the predetermined threshold). In this manner, the payload 120 is only liquefied and migrates through the migration region when the environmental condition exceeds the predetermined threshold and is solidified and does not migrate through the migration region when the environmental condition does not exceed the predetermined threshold. The payload 120 may be configured to solidify responsive to the environmental condition receding below the predetermined threshold.

In some examples, the migration region may be configured as the indicator region. As the payload 120 migrates through the wick 214, the payload 120 may cause the production of the observable effect in the portions of the wick 214 through which the payload 120 has migrated, and the portions of the wick 214 which the payload 120 has not migrated through remain in an initial state, where the observable effect has not (e.g., not yet) been produced.

In other examples, the indicator region 220 may be a feature or component located at the end of the wick 214, such that the payload 120 migrates along the wick 214, and after a predetermined period of time for which the activatable environmental exposure indicator 200A has been exposed to the environmental condition in excess of the predetermined threshold, the payload 120 reaches a destination feature, such as a demarcated portion of the wick 214 or a destination reservoir.

The viewing windows 222A-C are defined in the indicator region 220, such that a user may view portions of the wick 214 in which the payload 120 is configured to produce the observable effect to determine if the observable effect has been produced, and thus determined if the activatable environmental exposure indicator has been exposed to the predetermined environmental exposure. Additionally, in embodiments where the indicator region 220 includes a destination feature, the destination feature may be aligned with a respective viewing window 222.

The activatable environmental exposure indicator 200A may include various indices which correspond to different amounts of time that the activatable environmental exposure indicator 200A has been exposed to the environmental condition exceeding the predetermined threshold. In some examples, the viewing windows 222 are configured as a single window through which the migration region is viewable, and the cover layer includes printed indicia corresponding to indices within the migration region such that a the distance along the wick 214 that the payload has travelled is correlated to a specific interval of time which the activatable environmental exposure indicator 200A has been exposed to the environmental condition exceeding the predetermined threshold. In some examples, the viewing windows 222 includes several viewing windows 222A-C, each viewing window 222 disposed at a predetermined location relative to the wick 214 and the migration region, such that when the observable effect is viewable through a given viewing window 222, a user may determine that the activatable environmental exposure indicator 200 has been exposed to the environmental condition exceeding the predetermined threshold for at least the predetermined amount of time which corresponds to the given viewing window 222.

In various embodiments the indicator region 220 may include other components or take other forms. In some examples the indicator region 220 and the migration region may include microchannels or capillary tubes configured to support migration of the liquefied payload 120.

The payload 120 is configured to produce an observable effect upon reaching the indicator region 220. In some examples, the indicator material of the payload 120 is a dye, ink, or other colorant, and the wick 214 appears to change from an initial color state to a second color state as the wick 214 is saturated by the payload 120. In some examples, the indicator material is a two-component dye or ink, which produces a change in color state upon mixing two reactants together. In some examples, a first reactant (e.g., a color former) and a second reactant (e.g., a color developer) are separately held in separate microcapsules 100 where, upon release from the microcapsules 100, and the liquefaction of the liquefiable material, the first and second reactants are mixed, producing the color change which is transferred to the indicator region 220 as the liquefied payload 120 migrates thereto. In other examples, the first reactant is contained in the microcapsules 100 and the second reactant is contained in the indicator region 220, such that when the liquefied payload 120 reaches the indicator region 220 the first and second reactants are mixed, producing the color change in the indicator region 220.

In some examples, the indicator material in the payload 120 may be a flash material, which is configured to give off a bright appearance when illuminated with light of a predetermined wavelength. In some examples, the indicator material in the payload 120 may be a conductive material, such that the observable effect is a change in an electrical property of the indicator region 22, such as conductivity, resistivity, impedance, capacitance, and inductance.

As illustrated, the reservoir 212 is formed between the wick 214 and the depressible cover 216, and laterally bounded by the planarization layer 206. Additionally, the planarization layer 206 may define a recess, well, or hole at the activation region 210 which forms or houses the reservoir 212 in which the microcapsules 100 are disposed.

The depressible cover 216 is configured to be deformable, or extendable towards the substrate 202 and into the reservoir 212, so as to prevent substantial deformation of other components of the activatable environmental exposure indicator 200A, such as the wick 214 when the compressible force is applied to the activatable environmental exposure indicator 200A. In some examples, the depressible cover 216 may be uniformly deformable, and be constructed of a material which is distinct from the material from which cover layer 204 is constructed. In some examples the depressible cover 216 may be an area of the cover layer 204 which is defined by a line of weakness, the line of weakness configured to permit the depressible cover 216 to at least partially separate from the cover layer 204 to facilitate the deformation of the activation region 210. In some examples, the depressible cover 216 may include a deformable border portion, which is configured to permit an included rigid portion to extend below the plane of the cover layer 204 when the compressive force is applied. In some examples, the depressible cover 216 includes a surface which is rough in quality, or include a rough material, which is configured to aid in the rupturing of the microcapsules 100 when the activation action is applied thereto. When the compressive force is applied to the activation region 210, the rough surfaces may increase a proportion of the microcapsules 100 which are successfully ruptured by the activation action, thus increasing efficacy of the activatable environmental exposure indicator 200A and reducing potential for user error.

The substrate 202 may be, for example, paper such as a cellulose paper, a natural or synthetic polymer, or other materials. In some examples, the substrate 202 may provide a surface upon which indicia can be printed. In some examples, the substrate 202 may have a thickness in a range of about 10 mm to about 20 mm, from about 1 mm to about 10 mm or from about 10 mm to about 20 mm. As a non-limiting example, the substrate 202 may be one of a Polyolefin, polyamide, polypropylene, polyester Polyimide, Polyart synthetic paper, nylon, or PPG Teslin paper. In an example, there may be a topcoat applied to the substrate 202. Optionally, the substrate 202 may further include a release liner and/or an adhesive backing to allow the substrate 202 to be selectively attached to surfaces, e.g., as a label.

### Activatable Environmental Exposure Indicator: High Temperature Excursion Indicator

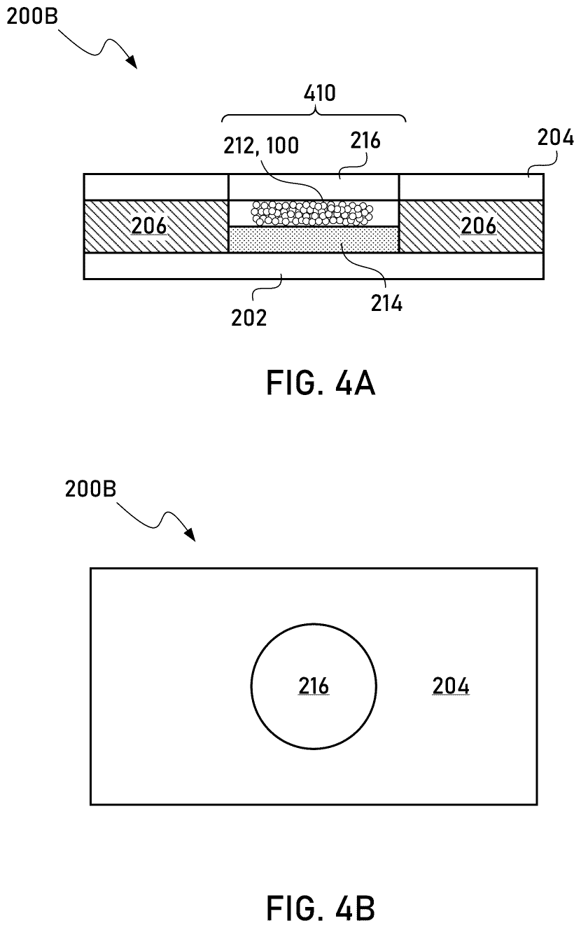

FIGS. 4A-4B illustrate a second embodiment of an activatable environmental exposure indicator 200B (e.g., high-temperature excursion indicator), according to embodiments of the present disclosure. The activatable environmental exposure indicator 200B includes a substrate 202, a wick 214, and a plurality of activatable microcapsules 100, each microcapsule 100 including a payload 120 microencapsulated in a frangible shell 110. The plurality of activatable microcapsules 100 is disposed adjacent to the wick 214, and generally contained in a reservoir 212. The activatable environmental exposure indicator 200 further includes a planarization layer 206 which overlays the substrate 202 and, in some examples, forms the reservoir 212 in which the microcapsules 100 are disposed. As illustrated, the activatable environmental exposure indicator 200 includes a cover layer 204 which overlays the planarization layer 206. Several features are shared between the first embodiment of the activatable environmental exposure indicator 200A and the second embodiment of the activatable environmental exposure indicator 200B, and except where noted and otherwise described, the discussion of the features of first embodiment of the activatable environmental exposure indicator 200A applies to the second embodiment of the activatable environmental exposure indicator 200B.

Generally, the activatable environmental exposure indicator 200 defines an operational region 410 which serves as both an activation region and as an indicator region. The operational region 410 is configured to receive a localized compressive force, (e.g., by a user) which activates the activatable environmental exposure indicator 200 to begin environmental sensing. The operational region 410 is the region of the activatable environmental exposure indicator 200 in which the payload 120 contained in the microcapsules 100 produces an observable effect after activation of the activatable environmental exposure indicator 200 and responsive to the activatable environmental exposure indicator 200 being exposed to a predetermined exposure. The payload 120 of the microcapsules 100 preferably has a very sharp melting point, and liquefies within a range of less than 2 degrees C., and has a viscosity (when liquefied) between 1 and 200 centipoise (cP), so as to liquefy and produce the observable effect rapidly responsive to the predetermined exposure.

The operational region 410 includes a depressible cover 216 which is configured to translate or deform upon receiving the localized compressive force (the localized compressive force being localized to the operational region 410, or more specifically to the depressible cover 216) such that the depressible cover transfers a compressive stress to the microcapsules 100, causing the frangible shells to rupture, releasing the payload 120.

After being released from the frangible shells 110, and responsive to a predetermined environmental exposure, the payload 120 liquefies and produces an observable effect in the wick 214.

Generally, the planarization layer 206 is configured to resist compressive forces applied to the activatable environmental exposure indicator 200B which are not exclusively localized to the activation region 210. In this manner, a delocalized compressive force applied to the activatable environmental exposure indicator 200B, (e.g., such as may be applied by a stamp, a roller, or a heavy object) does not impact the activatable environmental exposure indicator 200B in a manner that results in the rupture of the microcapsules 100. The discussion of the planarization layer 206 as it pertains to the first embodiment of the activatable environmental exposure indicator 200A is applicable to the second embodiment of the activatable environmental exposure indicator 200B.

Generally speaking, the activatable environmental exposure indicator 200B is configured to indicate (e.g., via the production of the observable effect in the operational region 410) that the activatable environmental exposure indicator 200B has been exposed to a predetermined environmental exposure, where the predetermined environmental exposure is at least a single excursion above (e.g., or below, in some examples) an exposure threshold of an environmental condition.

In some examples, the predetermined environmental exposure may be a temperature excursion above a predetermined temperature threshold, temperature excursion below a predetermined temperature threshold, an exposure to a particular chemical, an oxygen exposure, an ammonia exposure, an exposure to a particular chemical above a threshold concentration, an exposure to a particular chemical above the threshold concentration, an exposure to at least a predetermined amount of radiation of a particular type, a predetermined electromagnetic exposure, a humidity exposure, and an exposure to a humidity level above a predetermined threshold.

The payload 120 is configured to produce an observable effect upon liquefying responsive to the predetermined environmental exposure following being released from the frangible shells 110. In some examples, the indicator material of the payload 120 is a dye, ink, or other colorant, and the wick 214 appears to change from an initial color state to a second color state as the wick 214 is saturated by the payload 120. In other examples, the indicator material is a two-component dye or ink, which produces a change in color state upon mixing two reactants together. In some examples, a first reactant (e.g., a color former) and a second reactant (e.g., a color developer) are separately held in separate microcapsules 100 and embedded in respective liquefiable materials (e.g., embedded in solid matrices formed by the liquefiable materials), where upon release from the microcapsules 100, and the liquefaction of the liquefiable materials, the first and second reactants are mixed, producing the color change which is transferred to the operational region 410 as the liquefied payload 120 migrates thereto. In other examples, the first reactant is contained in the microcapsules 100 and the second reactant is contained in the operational region 410, such that when the liquefied payload 120 reaches the operational region 410 the first and second reactants are mixed, producing the color change in the operational region 410.

In some examples, the indicator material in the payload 120 may be a flash material, which is configured to give off a bright appearance when illuminated with light of a predetermined wavelength. In some examples, the indicator material in the payload 120 may be a conductive material, such that the observable effect is a change in an electrical property of the indicator region 220.

As illustrated, the reservoir 212 is formed between the wick 214 and the depressible cover 216, and laterally bounded by the planarization layer 206. Additionally, the planarization layer 206 may define a recess, well, or hole at the activation region 210 which forms or houses the reservoir 212 in which the microcapsules 100 are disposed.

The depressible cover 216 is configured to be deformable, or extendable towards the substrate 202 and into the reservoir 212, so as to prevent substantial deformation of other components of the activatable environmental exposure indicator 200A, such as the wick 214 when the compressible force is applied to the activatable environmental exposure indicator 200A. In some examples, the depressible cover 216 may be uniformly deformable, and be constructed of a material which is distinct from the material from which cover layer 204 is constructed. In some examples the depressible cover 216 may be an area of the cover layer 204 which is defined by a line of weakness, the line of weakness configured to permit the depressible cover 216 to at least partially separate from the cover layer 204 to facilitate the deformation of the activation region 210. In some examples, the depressible cover 216 may include a deformable border portion, which is configured to permit an included rigid portion to extend below the plane of the cover layer 204 when the compressive force is applied. In some examples, the depressible cover 216 includes a surface which is rough in quality, or include a rough material, which is configured to aid in the rupturing of the microcapsules 100 when the activation action is applied thereto. When the compressive force is applied to the activation region 210, the rough surfaces may increase a proportion of the microcapsules 100 which are successfully ruptured by the activation action, thus increasing efficacy of the activatable environmental exposure indicator 200A and reducing potential for user error.

The depressible cover 216 may also be configured to be at least partially transparent, such that the wick 214 is viewable to a user through the operational region 410, such that when the observable effect is produced, the observable effect is viewable or otherwise apparent to a user.

### Indicator Bulk Supply Roll

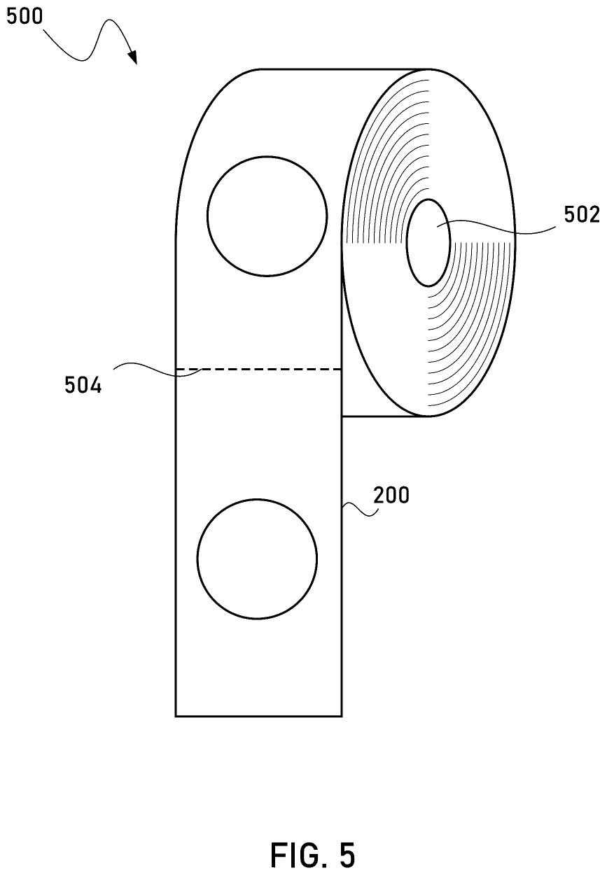

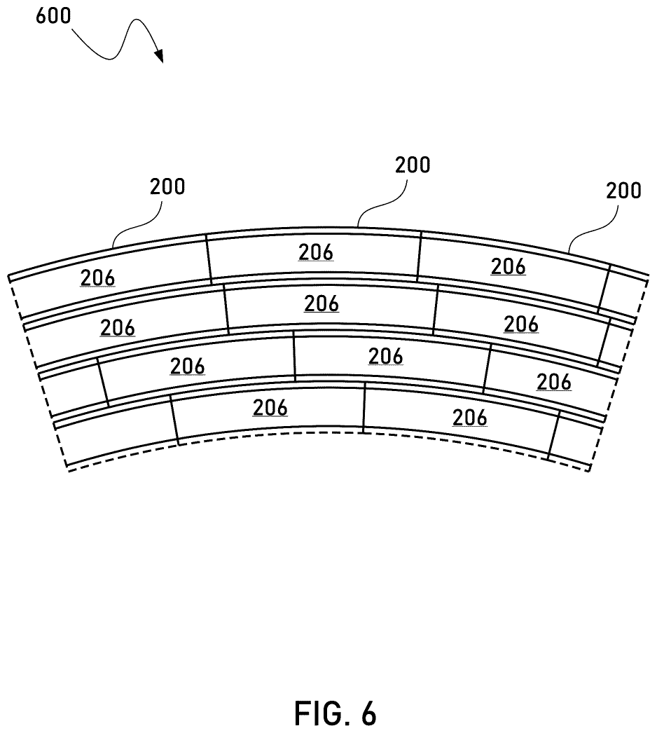

FIG. 5 illustrates a roll 500 of activatable environmental exposure indicators 200 and FIG. 6 illustrates a section profile of the roll 500, according to embodiments of the present disclosure. The roll 500 is formed of a web of activatable environmental exposure indicators 200 (e.g., activatable environmental exposure indicator 200A, activatable environmental exposure indicator 200B) wounds about a spool 502 (e.g., roll core). Each activatable environmental exposure indicator 200 in the web may be demarcated from another activatable environmental exposure indicator 200 in the web by a line of weakness 504. Although illustrated as a linear array having a single row of activatable environmental exposure indicators 200, the web of activatable environmental exposure indicators 200 include several rows of activatable environmental exposure indicators wound about the spool 502. The roll 500 may serve as a transportation, storage, or bulk supply configuration. As activatable environmental exposure indicator 200 are generally consumable, such bulk supplies may serve as an advantageous product format for sales. Other possible bulk formats, include webs stored in a fanfold stack, or stacks of separate labels.

When the activatable environmental exposure indicators 200 are wound about the spool 502 to form the roll 500, the activatable environmental exposure indicators 200 are wound with a predetermined winding tension as manner of eliminating space between sequential layers of activatable environmental exposure indicators 200 as the roll 500 is wound. This winding tension is converted into radial pressure (relative to the roll) as the roll 500 is progressively formed. The radial pressure is experienced by each activatable environmental exposure indicator 200 as a compressive force, felt more strongly by those activatable environmental exposure indicators 200 more proximate to the spool 502. This concept is illustrated by the roll section in FIG. 4B.

The planarization layer 206 of each activatable environmental exposure indicator 200 is configured to resist or absorb the compressive forces resulting from the radial forces present in the roll 500. In this manner, the radial pressures may generate compressive forces having sufficient magnitude to activate the activatable environmental exposure indicators 200, but the compressive forces, being uniformly applied to the indicators (e.g., not localized to the activation region 210 or operational region 410), are resisted by the planarization layers 206, preventing activation of the activatable environmental exposure indicators 200 and rupture of the microcapsules 100. Note that the planarization layers 206, while having sufficient compressive strength or rigidity to resist the compressive forces in the roll 500, is not so rigid as to prevent the activatable environmental exposure indicators 200 from being flexed to an extent sufficient for the indicators to be wound about the spool 502.

Generally, the planarization layer 206 of the activatable environmental exposure indicators 200 are configured to prevent activation when the compressive stresses from the radial forces of the roll 500 are at least as great as the compressive stresses of the localized compressive force required to activate the activatable environmental exposure indicators 200. Said differently, the planarization layer 206 of the activatable environmental exposure indicators 200 are configured to prevent activation when the compressive stresses resulting from internal radial forces of the roll 500 have a magnitude exceeding the activation pressure threshold. In some examples, the roll 500 may be wound with a winding tension defined in a range bounded by 5 pounds-force (lbf) and 50 lbf (e.g., about 0.035 psi to about 0.35 psi).

In the foregoing specification, specific embodiments have been described. However, one of ordinary skill in the art appreciates that various modifications and changes can be made without departing from the scope of the technology as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed technology is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. An activatable environmental exposure indicator, comprising:
a substrate;
an indicator region operatively coupled to the substrate;
a planarization layer, at least partially overlaying the substrate;
a reservoir disposed on or in the substrate, at least partially surrounded by the planarization layer, in fluid communication with the indicator region;
a plurality of microcapsules contained in the reservoir, each microcapsule of the plurality of microcapsules containing a payload microencapsulated in a frangible shell,
wherein the payload comprises a liquefiable material configured to liquefy responsive to a predetermined environmental exposure,
wherein the frangible shells are configured to rupture responsive to an activation action exceeding an activation threshold, releasing the payload from the frangible shells, and
wherein, after being released from the frangible shells, and responsive to the predetermined environmental exposure causing the liquefiable material to liquefy, the payload is configured to migrate into the indicator region producing an observable effect in the indicator region,
wherein the frangible shells are configured to block the payload from migrating to the indicator region prior to the activation action; and
a depressible cover aligned with and covering the reservoir;
wherein the depressible cover is configured to permit the activation action to be applied to the plurality of microcapsules by applying an activation compressive force having at least an activation magnitude to the depressible cover.

2. The activatable environmental exposure indicator of claim 1, wherein when a compressive force having a magnitude which is insufficient to cause plastic deformation to the planarization layer is applied uniformly across the activatable environmental exposure indicator, the planarization layer is configured to be strained within a predetermined range of compressive strain, such that the planarization layer blocks the plurality of microcapsules from rupturing.

3. The activatable environmental exposure indicator of claim 2, wherein an upper bound of the predetermined range corresponds to a strain at a yield point of the planarization layer.

4. The activatable environmental exposure indicator of claim 2, wherein the planarization layer is configured such that an upper bound of the predetermined range is a compressive strain between 0 and 0.75.

5. The activatable environmental exposure indicator of claim 2, wherein the magnitude of the compressive force is at least as great as the activation magnitude.

6. The activatable environmental exposure indicator of claim 5, wherein the magnitude of the compressive force is at least five times as great as the activation magnitude.

7. The activatable environmental exposure indicator of claim 1, wherein the depressible cover includes a rough surface aligned with the reservoir, the rough surface configured to facilitate rupturing the frangible shells when the depressible cover applies the activation action to the plurality of microcapsules.

8. The activatable environmental exposure indicator of claim 1, further comprising a cover layer overlaying the planarization layer and comprising a first viewing window through which the indicator region is viewable.

9. An article of manufacture comprising a plurality of the activatable environmental exposure indicators of claim 1, forming a connected web.

10. The article of manufacture of claim 9, wherein the connected web is wound onto a roll.

11. The article of manufacture of claim 10, wherein the planarization layer of each activatable environmental exposure indicator is configured to reduce compressive stresses resulting from radial forces of the roll from being transferred to the plurality of microcapsules and rupturing the plurality of microcapsules.

12. The article of manufacture of claim 11, wherein the compressive stresses resulting from internal radial forces of the roll exceed the activation magnitude.

13. The article of manufacture of claim 10, wherein the roll is wound with a winding tension having a magnitude defined within a range bounded by 5 pounds-force (lbf) and 50 lbf.

14. The activatable environmental exposure indicator of claim 1, further comprising a migration component, connectively disposed between the indicator region and the reservoir, and configured such that the payload, after being released from the frangible shells and when the liquefiable material is liquefied, migrates through the migration component.

15. (canceled)

16. (canceled)

17. (canceled)

18. (canceled)

19. (canceled)

20. (canceled)

21. (canceled)

22. (canceled)

23. The activatable environmental exposure indicator of claim 1, wherein the liquefiable material comprises a component material selected from a group consisting of: a side-chain crystalline polymer, an alkane, a wax, an alkane wax, esters, other polymeric materials, and combinations thereof.

24. The activatable environmental exposure indicator of claim 1, wherein the planarization layer is a composite materials including a component material selected form a group consisting of: silicone, plastics, paper, and combinations thereof.

25. An activatable environmental exposure indicator, comprising:
a substrate;
a planarization layer, at least partially overlaying the substrate;
an indicator region operatively coupled to the substrate and at least partially surrounded by the planarization layer;
a first plurality of microcapsules disposed in the indicator region, each microcapsule of the first plurality of microcapsules containing a payload microencapsulated in a frangible shell,
wherein the payload comprises a liquefiable material configured to liquefy responsive to a predetermined environmental exposure, and a first reactant material configured to produce an observable effect in the indicator region when reacted with a second reactant material,
wherein the frangible shells are configured to rupture responsive to an activation action exceeding an activation threshold, releasing the payload from the frangible shells, and
wherein, after being released from the frangible shells, and responsive to the predetermined environmental exposure causing the liquefiable material to liquefy, the first reactant material is exposed to the second reactant material, producing the observable effect,
wherein the frangible shells are configured to block the first reactant material from reacting with the second reactant material prior to the activation action; and
a depressible cover aligned with and covering the indicator region,
wherein the depressible cover is configured to permit the activation action to be applied to the first plurality of microcapsules by applying an activation compressive force having at least an activation magnitude to the depressible cover.

26. (canceled)

27. (canceled)

28. (canceled)

29. The activatable environmental exposure indicator of claim 25, wherein when a compressive force having a magnitude which is insufficient to cause plastic deformation to the planarization layer is applied uniformly across the activatable environmental exposure indicator, the planarization layer is configured to be strained within a predetermined range of compressive strain, such that the planarization layer blocks the plurality of microcapsules from rupturing.

30. (canceled)

31. (canceled)

32. The activatable environmental exposure indicator of claim 29, wherein the magnitude of the compressive force is at least as great as the activation magnitude.

33. (canceled)

34. The activatable environmental exposure indicator of claim 25, wherein the depressible cover includes a rough surface aligned with the first plurality of microcapsules, the rough surface configured to facilitate rupturing the frangible shells when the depressible cover applies the activation action to the first plurality of microcapsules.

35. (canceled)

36. An article of manufacture comprising a plurality of the activatable environmental exposure indicators of claim 25, forming a connected web.

37. The article of manufacture of claim 36, wherein the connected web is wound onto a roll.

38. The article of manufacture of claim 37, wherein the planarization layer of each activatable environmental exposure indicator is configured to reduce compressive stresses resulting from internal radial forces of the roll from being transferred to the first plurality of microcapsules and rupturing the first plurality of microcapsules.

39. The article of manufacture of claim 38, wherein the compressive stresses resulting from internal radial forces of the roll have a magnitude exceeding the activation magnitude.

40. The article of manufacture of claim 37, wherein the roll is wound with a winding tension having a magnitude defined within a range bounded by 5 pounds-force (lbf) and 50 lbf.
